(19) United States
(12) Patent Application Publication
(10) Pub. No.: US 2025/0282990 A1
(43) Pub. Date: Sep. 11, 2025

(54) SYSTEM AND METHOD FOR CONSUMING ACIDIC FLUIDS IN WELLS

(71) Applicant: Saudi Arabian Oil Company, Dhahran (SA)

(72) Inventors: Sultan S. Alotaibi, Kharj (SA); Talal O. Almutairi, Alahsa (SA); Mohammed A. Asiri, Alahsa (SA)

(73) Assignee: Saudi Arabian Oil Company, Dhahran (SA)

(21) Appl. No.: 18/596,326

(22) Filed: Mar. 5, 2024

(51) Int. Cl. C09K 8/72

(52) U.S. Cl. CPC C09K 8/725; C09K 2208/10; C09K 2208/32

(57) ABSTRACT

A method of consuming an acidic fluid in a wellbore comprises injecting a multilayer metallic ball into the wellbore, wherein the multilayer metallic ball comprises a core layer, a metallic layer encapsulating the core layer, and a ball density greater than the acidic fluid; contacting the multilayer metallic ball with the acidic fluid, thereby reacting at least a portion of the metallic layer with the acidic fluid at a first reaction rate and at least a portion of the core layer with the acidic fluid at a second reaction rate; and converting at least a portion of the acidic fluid to a spent acidic fluid.

### FIELD

The present disclosure relates to methods and systems of consuming acidic fluids, and particularly to methods and systems of consuming acidic fluids in a wellbore.

### BACKGROUND

Acid treatment (also referred to herein as acidizing) is commonly used to improve well productivity in oil and gas industry. Acidizing typically involves pumping an acidic fluid such as hydrogen chloride (HCl) or hydrogen fluoride (HF) into a wellbore and/or geologic formation to clean out debris or formation damage restricting flow in the wellbore or geologic formation. Other applications of acidizing (commonly referred to as fracture acidizing) may be used to dissolve formation rock in the geologic formation to create new flow paths to the wellbore or enlarge existing ones. Upon completion of acid treatment, acids in the acidic fluid are consumed and a spent fluid is produced. The spent fluid is typically benign.

### SUMMARY

However, if acid treatment is incomplete, for example, as a result of tight formation, acids in the acidic fluid may react with the casing or tubular materials, cause corrosion and material losses, and lead to compromised structural integrity, casing leakage, abnormal annular pressure, and other serious concerns. In this case, the acidic fluid should be immediately removed. The unreacted acidic fluid may be circulated out the well into an acid tank above the surface and subsequently neutralized in the acid tank. However, the removal and neutralization processes pose great safety threats to field operators. Additionally, immediate removal of the unreacted acidic fluid may not be practically feasible until a removal device, such as a coiled tubing, is available and can be deployed into the well. Until then, the acidic fluid remains in the well and continues reacting with the casing and tubular materials.

Accordingly, a need exists to develop methods and systems that are capable of consuming unreacted acids directly in a wellbore to minimize damages to the wellbore and safety threats to the field operators.

The present disclosure is directed to methods of and systems for consuming acids in an acidic fluid in a wellbore. For example, an unreacted acidic fluid may be converted to a spent acidic fluid in the wellbore before being circulated out the well, and therefore, the need for subsequent acid neutralization in an acid tank is diminished and therefore the safety threats to the field operators are minimized. Further, once the acidic fluid has been converted to the spent acidic fluid, the spent acidic fluid is less reactive than the acidic fluid and thus less likely to react with the casing or tubular material and damage the wellbore.

Embodiments of the present disclosure address these needs by utilizing at least one multilayer metallic ball to consume an acidic fluid in a wellbore and, in particular, at least one multilayer metallic ball that is capable of outcompeting and/or impeding the reaction between the acid fluid and metal components in the wellbore, such as a tubing or a casing.

For example, the casing, the tubing, or combinations thereof may react with the acidic fluid at a third reaction rate (R₃). In embodiments, the multilayer metallic balls may comprise a core layer and a metallic layer encapsulating the core layer. The metallic layer may be configured to react with the acidic fluid at a first reaction rate (Rₘₑₜₐₗ) greater than or equal to 5 times and less than or equal to 200 times of the third reaction rate (R₃), and the core layer may be configured to react with the acidic fluid at a second reaction rate (R_{core}) greater than or equal to 100 times and less than or equal to 5000 times of the third reaction rate (R₃). The multilayer metallic balls may further comprise a ball density greater than the acidic fluid. Therefore, upon injecting the multilayer metallic ball into the acidic fluid in the wellbore, the multilayer metallic ball will begin reacting with the acidic fluid and simultaneously sinking downwards in the wellbore. While sinking downwards, the metallic ball will continue reacting with the acidic fluid.

In accordance with one embodiment of the present disclosure, a method of consuming an acidic fluid in a wellbore may comprise injecting at least one multilayer metallic ball into the wellbore, wherein the at least one multilayer metallic ball comprises a core layer, a metallic layer encapsulating the core layer, and a ball density greater than the acidic fluid; contacting the at least one multilayer metallic ball with the acidic fluid, thereby reacting at least a portion of the metallic layer with the acidic fluid at a first reaction rate (Rₘₑₜₐₗ) and exposing at least a portion of the core layer; and contacting the core layer with the acidic fluid, thereby reacting at least a portion of the core layer with the acidic fluid at a second reaction rate (R_{core}) and consuming at least a portion of the core layer, wherein reacting at least a portion of the metallic layer or the core layer with the acidic fluid converts at least a portion of the acidic fluid to a spent acidic fluid and forms a mixture of the acidic fluid and the spent acidic fluid.

In accordance with another embodiment of the present disclosure, a system for consuming an acidic fluid in a wellbore may comprise the wellbore; the acidic fluid in the wellbore; and at least one multilayer metallic ball comprising a core layer, a metallic layer encapsulating the core layer, and a ball density greater than the acidic fluid, wherein the metallic layer is configured to react with the acidic fluid at a first reaction rate (Rₘₑₜₐₗ) and thereby convert a portion of the acidic fluid to a spent acidic fluid, the acidic fluid and the spent acidic fluid forming a mixture, and the core layer is configured to react with the acidic fluid at a second reaction rate (R_{core}) and thereby convert another portion of the acidic fluid to additional spent acidic fluid.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1A illustrates a system for consuming an acidic fluid in a wellbore;

FIG. 1B illustrates a cross-sectional view of the wellbore;

FIG. 1C illustrates a multilayer metallic ball for consuming the acidic fluid in the wellbore;

FIG. 2 illustrates reacting the multilayer metallic ball with the acidic fluid in the wellbore; and

FIG. 3 illustrates a method of consuming the acidic fluid in the wellbore; specifically,

FIG. 3A illustrates the acidic fluid is being injected into the wellbore;

FIG. 3B illustrates at least one multilayer metallic ball is introduced into the wellbore contacting the acidic fluid, reacting with the acidic fluid, converting the acidic fluid to a spent acidic fluid; and forming a mixture of the acidic fluid and the spent acidic fluid;

FIG. 3C illustrates a displacement is injected into the wellbore upon determining completions of consuming the acidic fluid; and

FIG. 3D illustrates the mixture of the acidic fluid and the spent acidic fluid is being displaced by the displacement and flows toward to a surface of the wellbore.

### DETAILED DESCRIPTION

As used herein, “acid” includes, but is not limited to, a Brønsted-Lowry acid, a proton donor, or an electron acceptor. Examples of acids may comprise inorganic acids, such as sulfuric, nitric, hydrochloric, hydrofluoric, and phosphoric acids, as well as organic acids, such as carboxylic acids, sulfonic acids, and phenol groups.

As used herein, “consume” or “consuming” an acidic fluid means a chemical reaction or a physical process in which acids in the acidic fluid are being reduced or removed.

As used throughout this disclosure, the terms “downward” and “upward” may refer to a position within a wellbore relative to the surface, with upward indicating direction or position closer to the surface and downward referring to direction or position farther away from the surface.

As described in the present disclosure, a “geologic formation” may refer to a body of rock that is sufficiently distinctive and continuous from the surrounding rock bodies that the body of the rock may be mapped as a distinct entity. A geologic formation is, therefore, sufficiently homogenous to form a single identifiable unit containing similar properties throughout the geologic formation, including, but not limited to, porosity and permeability.

As used herein, “impeding” a reaction means that the reaction is hindered, obstructed, inhibited, blocked, or delayed by another competing chemical reaction or by a physical process that consumes or removes a reactant of the reaction or that produces or adds a product of the reaction such that the reaction is disfavored.

As used herein, “outcompeting” a reaction means that the reaction is surpassed, defeated, reduced, outdone, or displaced by another competing reaction that is more effective or aggressive. For example, if the reaction and the competing reaction have a common reactant (e.g. acids), the occurrence of the reaction may become less probable if the number density (e.g. concentration or surface area) of the common reactant is reduced by the faster, more effective, more aggressive competing reaction.

As used throughout this disclosure, “wellbore,” may refer to a drilled hole or borehole extending from the surface of the Earth down to the geologic formation, including the openhole or uncased portion. The wellbore may form a pathway capable of permitting fluids to traverse between the surface and the geologic formation. The wellbore may include at least a portion of a fluid conduit that links the interior of the wellbore to the surface. The fluid conduit connecting the interior of the wellbore to the surface may be capable of permitting regulated fluid flow from the interior of the wellbore to the surface and may permit access between equipment on the surface and the interior of the wellbore.

Reference will now be made in detail to embodiments of systems for consuming an acidic fluid in a wellbore.

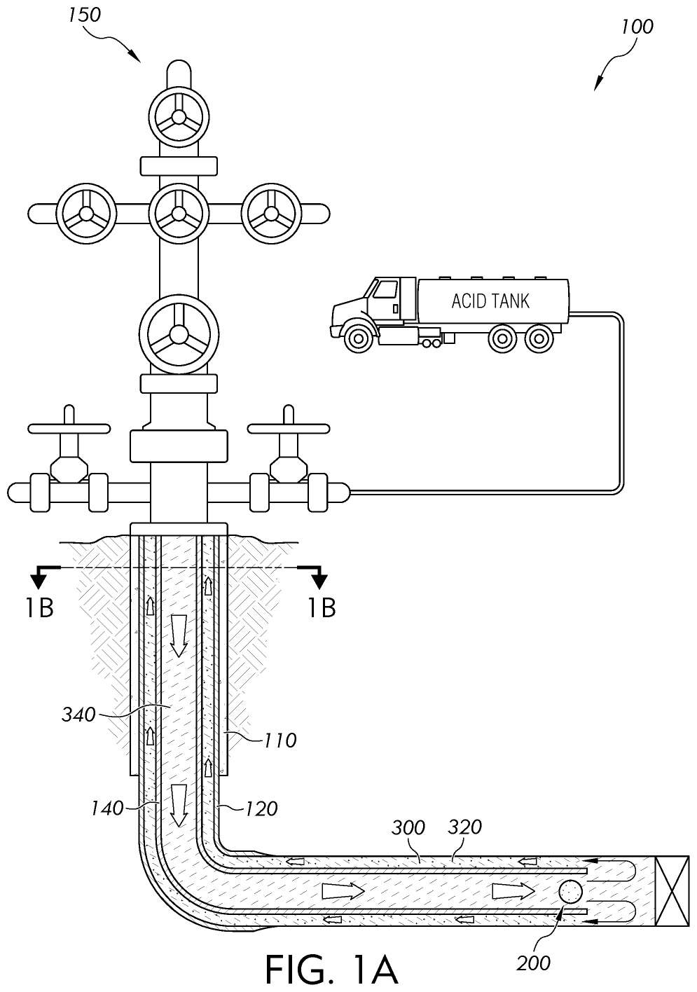

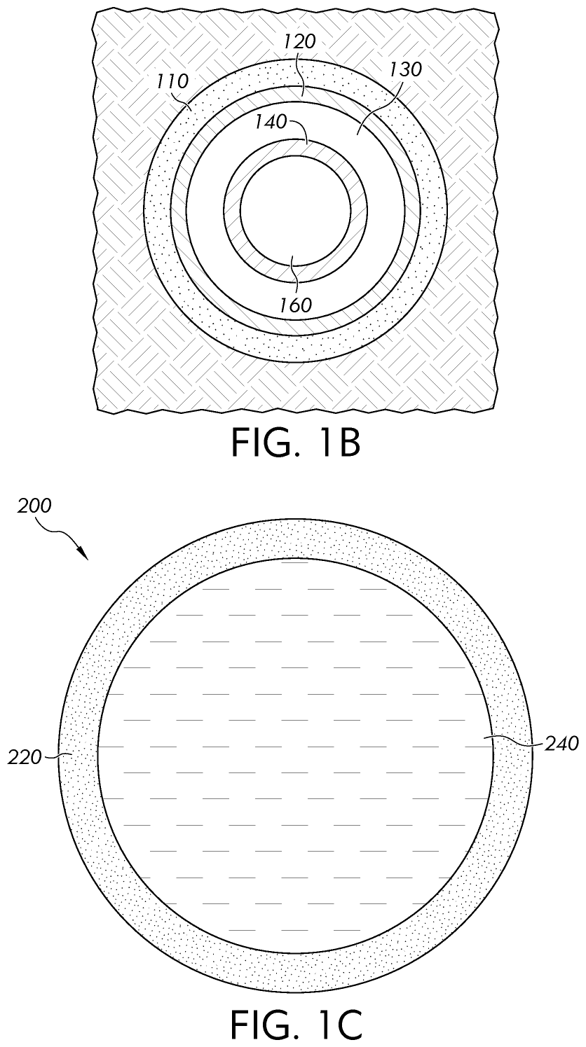

Referring initially to FIG. 1A, according to embodiments, a system 100 for consuming an acidic fluid 300 in a wellbore 110 may comprise the wellbore 110; the acidic fluid 300 in the wellbore 110; and at least one multilayer metallic ball 200. In some embodiments, the wellbore 110 may also comprise a casing 120, a tubing 140, or combinations thereof. In some embodiments, the system 100 may further comprise a wellhead 150 connected to the wellbore 110, such as by the casing 120, the tubing 140, or both. As shown in FIG. 1B, and in one or more embodiments, the wellbore 110 may further comprise a wellbore annulus 130 defined by an inner diameter of the wellbore 110 or the casing 120 and an outer diameter of the tubing 140. In some embodiments, the wellbore annulus 130 may be defined by the inner diameter of the wellbore 110 and an outer diameter of the casing 120. In other embodiments, the wellbore 110 may comprise a plurality of casings 120, and the wellbore annulus 130 may be defined by an inner diameter of a casing and an outer diameter of another casing.

Referring now to FIG. 1C, the at least one multilayer metallic ball 200 may comprise a core layer 240 and a metallic layer 220 encapsulating the core layer 240. The at least one multilayer metallic ball 200 may also comprise a ball density greater than the acidic fluid. The metallic layer 220 may be configured to react with the acidic fluid 300 at a first reaction rate (Rₘₑₜₐₗ) and thereby convert a portion of the acidic fluid 300 to a spent acidic fluid 320. The acidic fluid 300 and the spent acidic fluid 320 may together form a mixture. The core layer 240 may also be configured to react with the acidic fluid 300 at a second reaction rate (R_{core}) and thereby convert another portion of the acidic fluid 300 to additional spent acidic fluid 320.

In embodiments, the metallic layer 220 and the core layer 240 may be made from materials that may effectively outcompete and/or impede the reaction between the acidic fluid 300 and the at least a portion of the casing 120, the tubing 140, or combinations thereof; that is, a rate of the reaction between the acidic fluid 300 and the at least one multilayer metallic ball 200 is greater than a rate of the reaction between the acidic fluid 300 and the wellbore 110, such as the casing 120, the tubing 140, or combinations thereof.

For example, and in embodiments, the casing 120, the tubing 140, or combinations thereof may react with the acidic fluid 300 at a third reaction rate (R₃). The first reaction rate (Rₘₑₜₐₗ) may be relatively greater than the third reaction rate (R₃), such that the metal layer may be consumed within 18 hours, such as within 15 hours, within 12 hours, or within 6 hours. The second reaction rate (R_{core}) may also be relatively greater than the third reaction rate (R₃), such that the core layer may be consumed within 24 hours, such as within 18 hours, within 12 hours, within 6 hours, or within 3 hours.

Without being limited by theory, the first and second reaction rates being greater than the third reaction rates may enable the depletion or reduction of acids in the acidic fluid 300 and thus slow or stop the reaction between the acidic fluid and the casing 120, the tubing 140, or combinations thereof, minimizing the chances of wellbore corrosion, material loss, or loss of wellbore integrity.

Further, a reaction rate may be concentration-dependent. That is, once the metallic layer 220 begins to react with a portion of the acidic fluid 300, the concentration of acids in the acidic fluid 300 begins to reduce, and therefore the first rate (Rₘₑₜₐₗ) of reaction between the acidic fluid 300 and the metallic layer 220 may begin to reduce. Therefore, in order to maintain the overall reactivity between the at least one multilayer metallic ball 200 and the acidic fluid 300, the second reaction rate (R_{core}) between the acidic fluid 300 and the core layer 240 may be greater than the first reaction rate (Rₘₑₜₐₗ) between the acidic fluid 300 and the metallic layer 220 and further greater than the third reaction rate (R₃) between the acidic fluid 300 and the casing 120, the tubing 140, or combinations thereof.

Other variables such as the composition and surface area may also affect the reaction rate. In one or more embodiments, the metallic layer 220 may comprise a metallic material. The metallic material of the metallic layer 220 may comprise alkaline earth metals, aluminum, tin, zinc, cerium, neodymium, iron, nickel, lead, or combinations thereof. In further embodiments, the metallic layer may further comprise a non-metallic material, such as a blend of metallic and non-metallic materials. The non-metallic material of the metallic layer 220 may comprise oxides, carbonates, polymers, or combinations thereof. The oxides may be selected from one or more of silica, alumina, iron oxides, cerium oxides, neodymium oxides, titanium oxides, andradite, alkaline metal oxides, copper oxides, and manganese oxide. The carbonates may be selected from one or more of calcium carbonates, magnesium carbonates, and iron carbonates. The polymers may be selected from one or more of polysaccharides, polyacrylic acids, polylactic acids, and poly(vinylalcohol)s. For example, and in embodiments, the metallic layer 220 may comprise a blend of alkaline earth metals and aluminum. In further embodiments, the metallic layer 220 may comprise aluminum and a blend of calcium carbonates, polysaccharides, polyacrylic acids, and combinations thereof. In other further embodiments, the metallic layer 220 may comprise alkaline earth metals and a blend of calcium carbonates, polysaccharides, polyacrylic acids, and combinations thereof.

Where the metallic layer 220 comprises a blend of the metallic material and the non-metallic material, the metallic material may comprise from 5 wt. % to 99.9 wt. % of the total weight of the metallic layer, such as 5 wt. % to 10 wt. %, from 10 wt. % to 30 wt. %, from 30 wt. % to 50 wt. %, from 50 wt. % to 70 wt. %, from 70 wt. % to 99.9 wt. %, or any combination of the previous ranges or smaller range therein, such as from 5 wt. % to 25 wt. %, 5 wt. % to 20 wt. %, 5 wt. % to 15 wt. %, from 10 wt. % to 25 wt. % from 10 wt. % to 20 wt. %, from 10 wt. % to 15 wt. %, from 15 wt. % to 25 wt. %, from 15 wt. % to 20 wt. %, or from 20 wt. % to 25 wt. %.

Now reference to the composition of the core layer 240, according to embodiments, the core layer 240 may comprise a metallic material, a non-metallic material, or combinations thereof.

In one or more embodiments, the metallic material of the core layer 240 may comprise alkaline earth metals, aluminum, tin, zinc, cerium, neodymium, iron, nickel, lead, or combinations thereof.

In one or more embodiments, the non-metallic material of the core layer 240 may comprise oxides, carbonates, polymers, or combinations thereof. The oxides may be selected from one or more of silica, alumina, iron oxides, cerium oxides, neodymium oxides, titanium oxides, andradite, alkaline metal oxides, copper oxides, and manganese oxide. The carbonates may be selected from one or more of calcium carbonates, magnesium carbonates, and iron carbonates. The polymers may be selected from one or more of polysaccharides, polyacrylic acids, polylactic acids, and poly(vinylalcohol)s.

For example, in further embodiments, the core layer 240 may comprise polymers comprising from 0.1 wt. % to 95 wt. % of the total weight of the core layer, such as from 0.1 wt. % to 15 wt. %, from 15 wt. % to 30 wt. %, from 30 wt. % to 40 wt. %, from 40 wt. % to 50 wt. %, from 50 wt. % to 70 wt. %, from 70 wt. % to 95 wt. %, or any combination of the previous ranges or smaller range therein, such as from 10 wt. % to 35 wt. %, from 10 wt. % to 30 wt. %, from 10 wt. % to 25 wt. %, from 10 wt. % to 20 wt. %, from 10 wt. % to 15 wt. %, from 15 wt. % to 35 wt. %, from 15 wt. % to 30 wt. %, from 15 wt. % to 25 wt. %, from 15 wt. % to 20 wt. %, from 20 wt. % to 35 wt. %, from 20 wt. % to 30 wt. %, from 20 wt. % to 25 wt. %, from 25 wt. % to 35 wt. %, from 25 wt. % to 30 wt. %, or from 30 wt. % to 35 wt. %.

In one or more embodiments, the core layer 240 may comprise a combination of the metallic material and the non-metallic material.

For example, and in further embodiments, the metallic material may comprise 5 wt. % to 99.9 wt. % of the total weight of the core layer 240, such as from 5 wt. % to 10 wt. %, from 10 wt. % to 30 wt. %, from 30 wt. % to 50 wt. %, from 50 wt. % to 70 wt. %, from 70 wt. % to 99.9 wt. %, or any combination of the previous ranges or smaller range therein, such as from 5 wt. % to 20 wt. %, from 5 wt. % to 15 wt. %, from 5 wt. % to 10 wt. %, from 5 wt. % to 8 wt. %, from 8 wt. % to 20 wt. %, from 8 wt. % to 15 wt. %, from 8 wt. % to 10 wt. %, from 10 wt. % to 20 wt. %, from 10 wt. % to 15 wt. %, or from 15 wt. % to 20 wt. %. For example, and in other embodiments, the non-metallic material may comprise from 0.1 wt. % to 95 wt. % of the total weight of the core layer 240, such as from 0.1 wt. % to 15 wt. %, from 15 wt. % to 30 wt. %, 30 wt. % to 40 wt. %, from 40 wt. % to 50 wt. %, from 50 wt. % to 70 wt. %, from 70 wt. % to 95 wt. %, or any combination of the previous ranges or smaller range therein, from 10 wt. % to 35 wt. %, from 10 wt. % to 30 wt. %, from 10 wt. % to 25 wt. %, from 10 wt. % to 20 wt. %, from 10 wt. % to 15 wt. %, from 15 wt. % to 35 wt. %, from 15 wt. % to 30 wt. %, from 15 wt. % to 25 wt. %, from 15 wt. % to 20 wt. %, from 20 wt. % to 35 wt. %, from 20 wt. % to 30 wt. %, from 20 wt. % to 25 wt. %, from 25 wt. % to 35 wt. %, from 25 wt. % to 30 wt. %, or from 30 wt. % to 35 wt. %.

In addition to the compositions stated hereinabove, it is also contemplated that the metallic layer 220 and the core layer 240 may individually further comprise at least one additive such as an acid inhibitor. The acid inhibitor may hinder, inhibit, block, or slow down the reaction between the acid fluid 300 and the metal components (e.g. the casing 120 or the tubing 140) in the wellbore 110, and therefore protect these metal components from the corrosive acidic fluid 300.

Regarding the dimension of the at least one multilayer metallic ball 200, according to embodiments, the at least one multilayer metallic ball 200 may comprise an initial radius of from 0.05 cm to 5 cm before the at least one multilayer metallic ball 200 is injected into the wellbore, such as from 0.05 cm to 1 cm, from 0.1 cm to 0.5 cm, from 0.5 cm to 1 cm, from 1 cm to 1.5 cm, from 1.5 cm to 2 cm, from 2 cm to 2.5 cm, from 2.5 cm to 3.5 cm, from 3 cm to 3.5 cm, from 3.5 cm to 4 cm, from 4 cm to 4.5 cm, from 4.5 cm to 5 cm, or any combination of the previous ranges or smaller range therein, such as from 2 cm to 5 cm, from 2 cm to 4.5 cm, from 2 cm to 4 cm, from 2 cm to 3.5 cm, from 2 cm to 3 cm, from 2 cm to 2.5 cm, from 2.5 cm to 5 cm, from 2.5 cm to 4.5 cm, from 2.5 cm to 4 cm, from 2.5 cm to 3.5 cm, from 2.5 cm to 3 cm, from 3 cm to 5 cm, from 3 cm to 4.5 cm, from 3 cm to 4 cm, from 3 cm to 3.5 cm, from 3.5 cm to 5 cm, from 3.5 cm to 4.5 cm, from 3.5 cm to 4 cm, from 4 cm to 5 cm, from 4 cm to 4.5 cm, or from 4.5 cm to 5 cm.

Further, as stated hereinabove, surface areas of individual layers may affect the reaction rate. Without being bound by any particular theory, increasing the surface area-to-volume ratio of materials may exposing more of the materials to the surrounding environment and therefore increasing reactivity or accelerating chemical reactions of these materials.

Therefore, according to embodiments, the at least one multilayer metallic ball 200 may individually comprise an initial radius of from 5 nm to 500 μm before the at least one multilayer metallic ball 200 is injected into the wellbore, such as from 5 nm to 200 nm, from 200 nm to 500 μm, from 500 nm to 1 μm, from 1 μm to 50 μm, from 50 μm to 100 μm, from 100 μm to 150 μm, from 150 μm to 200 μm, from 200 μm to 250 μm, from 250 μm to 300 μm, from 300 μm to 350 μm, from 350 μm to 400 μm, from 400 μm to 450 μm, from 450 μm to 500 μm, or any combination of the previous ranges or smaller range therein, such as from 100 μm to 250 μm, from 100 μm to 200 μm, from 100 μm to 175 μm, from 100 μm to 150 μm, from 150 μm to 250 μm, from 150 μm to 200 μm, from 150 μm to 175 μm, from 175 μm to 250 μm, from 175 μm to 200 μm, or from 200 μm to 250 μm.

Varying the material structures may also increase surface areas of the metallic layer 220 and/or the core layer 240. Therefore, in embodiments, the metallic layer 220 and the core layer 240 may individually comprise various material structures such as crystalline material, porous material, amorphous material, or agglomerates. For example, the metallic layer 220 and the core layer 240 may be individually formed by compacting a plurality of nanoparticles comprising compositions described hereinabove, and upon contacting an acidic fluid and initiating the acid degradation, the compacts or agglomerates of nanoparticles would break into individual particles or groups of particles increasing the total surface area and thus acid reactivity.

For example, and in embodiments, the at least one multilayer metallic ball 200 may comprise an initial radius of from 0.05 cm to 5 cm before the at least one multilayer metallic ball 200 is injected into the wellbore, and the metallic layer 220 and the core layer 240 of the at least one multilayer metallic ball 200 may be individually formed by compacting nanoparticles of metallic materials, non-metallic materials, or both. In further embodiments, the nanoparticles of metallic materials, non-metallic materials, or both may comprise a diameter of from 5 nm to 200 nm, such as from 5 nm to 20 nm, from 20 nm to 40 nm, from 40 nm to 60 nm, from 60 nm to 80 nm, from 80 nm to 100 nm, from 100 nm to 200 nm, or any combination of the previous ranges or smaller range therein, such as from 5 nm to 175 nm, from 5 nm to 150 nm, from 5 nm to 125 nm, from 5 nm to 100 nm, from 5 nm to 75 nm, from 5 nm to 50 nm, from 5 nm to 25 nm, from 25 nm to 175 nm, from 25 nm to 150 nm, from 25 nm to 125 nm, from 25 nm to 100 nm, from 25 nm to 75 nm, from 25 nm to 50 nm, from 50 nm to 175 nm, from 50 nm to 150 nm, from 50 nm to 125 nm, from 50 nm to 100 nm, from 50 nm to 75 nm, from 75 nm to 175 nm, from 75 nm to 150 nm, from 75 nm to 125 nm, from 75 nm to 100 nm, from 100 nm to 175 nm, from 100 nm to 150 nm, from 100 nm to 125 nm, from 125 nm to 175 nm, from 125 nm to 150 nm, or from 150 nm to 175 nm.

Regarding the density of the at least one multilayer metallic ball 200, the at least one multilayer metallic ball 200 may initially comprise a ball density greater than the fluid density so that the at least one multilayer metallic ball 200 may sink to the bottom of the wellbore 110 or a horizontal section of the wellbore, begin to react with the acidic fluid while descending down the wellbore 110 and continue to react with the acidic fluid at the bottom of the wellbore 110 or in the horizontal section of the wellbore 110.

According to embodiments, the at least one multilayer metallic ball 200 may initially comprise the ball density (d_{Ball}) of from 1.2 g/cm³ to 8.9 g/cm³; and the acidic fluid 300 may comprise the fluid density (d_{fluid}) of from 1.0 g/cm³ to 1.9 g/cm³ before the at least one multilayer metallic ball 200 contacts the acidic fluid and start reacting with the acidic fluid. For example, the initial ball density may be from 1.2 g/cm³ to 7.5 g/cm³, from 1.2 g/cm³ to 5.0 g/cm³, from 1.2 to 2.5 g/cm³, from 2.5 g/cm³ to 8.9 g/cm³, from 2.5 g/cm³ to 7.5 g/cm³, from 2.5 g/cm³ to 5.0 g/cm³, from 5.0 g/cm³ to 8.9 g/cm³, from 5.0 g/cm³ to 7.5 g/cm³, or from 7.5 g/cm³ to 8.9 g/cm³. For example, the initial fluid density may be from 1.0 g/cm³ to 1.7 g/cm³, from 1.0 g/cm³ to 1.5 g/cm³, from 1.0 g/cm³ to 1.3 g/cm³, from 1.3 g/cm³ to 1.7 g/cm³, from 1.3 g/cm³ to 1.5 g/cm³, or from 1.5 g/cm³ to 1.7 g/cm³.

The density of the at least one multilayer metallic ball 200 may be altered by varying the composition of the metallic layer 220 and/or the composition of the core layer 240 such that the at least one multilayer metallic ball 200 may sink, suspend, or float in the fluid at different stages of degradation.

For example, and in embodiments, a core density (d_{core}) of the core layer 240 may be greater than the fluid density (d_{fluid}) such that, after a portion of the metallic layer 220 has been consumed, the at least one multilayer metallic ball 200 or the core layer 240 may continue descending down the wellbore 110, remaining sunk at the bottom of the wellbore 110, and therefore reaching the bottom of the wellbore 110 to consume the acidic fluid 300 there. According to embodiments, the core layer 240 may comprise a core density (d_{core}) from 0.92 g/cm³ to 1.5 g/cm³, from 0.92 g/cm³ to 1.1 g/cm³, or from 1.1 g/cm³ to 1.5 g/cm³; and the core density (d_{core}) is less than or equal to the fluid density d_{fluid} such that the core layer 240 suspends in the acidic fluid 300, the spent acidic fluid 320, the displacement fluid 340, or combinations thereof. For example, and in one or more embodiments, the suspending or floating core layer 240 may comprise polymers comprising from 70 wt. % to 95 wt. % of the total weight of the core layer 240, such as from 70 wt. % to 75 wt. %, from 75 wt. % to 80 wt. %, from 80 wt. % to 85 wt. %, from 85 wt. % to 90 wt. %, from 90 wt. % to 95 wt. %, or any combination of the previous ranges or smaller range therein, such as from 70 wt. % to 90 wt. %, from 70 wt. % to 85 wt. %, from 70 wt. % to 80 wt. %, from 75 wt. % to 95 wt. %, from 75 wt. % to 85 wt. %, from 80 wt. % to 95 wt. %, from 80 wt. % to 90 wt. %, or from 85 wt. % to 95 wt. %.

For another example, the core density (d_{core}) may be less than or equal to the fluid density (d_{fluid}) such that, after a portion of the metallic layer has been consumed, the at least one multilayer metallic ball 200 or the core layer 240 may suspend or float in the mixture of the acidic fluid 300 and the spent acidic fluid 320. Subsequently, the at least one partially-consumed multilayer metallic ball 200 or the core layer 240 may be circulated along with the mixture fluid or the displacement fluid to the surface of the wellbore 110 to be removed or recollected. Also, during the removal process, the at least one multilayer metallic ball 200 or core layer 240 may continue reacting with residual acids in the mixture fluid. According to embodiments, the core layer 240 may comprise a core density (d_{core}) from 1.5 g/cm³ to 7.2 g/cm³, from 1.5 g/cm³ to 3.5 g/cm³, or from 3.5 g/cm³ to 7.2 g/cm³; and the core density (d_{core}) is greater than the fluid density d_{fluid} such that the core layer 240 sinks in the acidic fluid 300. In this instance, and in one or more embodiments, the sinking core layer 240 may comprise metallic materials, oxides, carbonates, or combinations thereof comprising greater than 30 wt. % of the total weight of the core layer, such as greater than 50 wt. %, greater than 70 wt. %, greater than 90 wt. %, greater than 95 wt. %, from from 30 wt. % to 50 wt. %, from 50 wt. % to 70 wt. %, from 70 wt. % to 90 wt. %, from 90 wt. % to 95 wt. %, from 95 wt. % to 99.9 wt. %, or any combination of the previous ranges or smaller range therein, such as from 85 wt. % to 99.9 wt. %, from 85 wt. % to 95 wt. %, from 85 wt. % to 90 wt. %, or from 90 wt. % to 99.9 wt. %.

Regarding the density of the metallic layer 220, in one or more embodiments, the metallic layer 220 may comprise a metal density (dₘₑₜₐₗ) from 2.0 g/cm³ to 11.3 g/cm³, such as from 2.0 g/cm³ to 9.0 g/cm³, from 2.0 g/cm³ to 6.0 g/cm³, from 2.0 g/cm³ to 4.5 g/cm³, from 4.5 g/cm³ to 11.3 g/cm³, from 4.5 g/cm³ to 9.0 g/cm³, from 4.5 g/cm³ to 6.0 g/cm³, from 6.0 g/cm³ to 11.3 g/cm³, from 6.0 g/cm³ to 9.0 g/cm³, or from 9.0 g/cm³ to 11.3 g/cm³.

The density of the metallic layer 220 may be adjusted by varying the metallic layer 220 composition by blending metallic materials with non-metallic materials. For example, and in further embodiments, the metallic material may comprise 5 wt. % to 99.9 wt. % of the total weight of the metallic layer 220, such as from 5 wt. % to 10 wt. %, from 10 wt. % to 30 wt. %, from 30 wt. % to 50 wt. %, from 50 wt. % to 70 wt. %, from 70 wt. % to 99.9 wt. %, or any combination of the previous ranges or smaller range therein, such as from 45 wt. % to 75 wt. %, from 45 wt. % to 70 wt. %, from 45 wt. % to 65 wt. %, from 45 wt. % to 60 wt. %, from 45 wt. % to 55 wt. %, from 45 wt. % to 50 wt. %, from 50 wt. % to 75 wt. %, from 50 wt. % to 65 wt. %, from 50 wt. % to 60 wt. %, from 50 wt. % to 55 wt. %, from 55 wt. % to 75 wt. %, from 55 wt. % to 70 wt. %, from 55 wt. % to 65 wt. %, from 55 wt. % to 60 wt. %, from 60 wt. % to 75 wt. %, from 60 wt. % to 70 wt. %, from 60 wt. % to 65 wt. %, from 65 wt. % to 75 wt. %, from 65 wt. % to 70 wt. %, or from 70 wt. % to 75 wt. %. For example, and in other embodiments, the non-metallic material may comprise from 0.1 wt. % to 95 wt. % of the total weight of the metallic layer 220, such as from 0.1 wt. % to 15 wt. %, from 15 wt. % to 30 wt. %, from 30 wt. % to 40 wt. %, from 40 wt. % to 50 wt. %, from 50 wt. % to 70 wt. %, from 70 wt. % to 95 wt. %, or any combination of the previous ranges or smaller range therein, such as from 45 wt. % to 75 wt. %, from 45 wt. % to 70 wt. %, from 45 wt. % to 65 wt. %, from 45 wt. % to 60 wt. %, from 45 wt. % to 55 wt. %, from 45 wt. % to 50 wt. %, from 50 wt. % to 75 wt. %, from 50 wt. % to 65 wt. %, from 50 wt. % to 60 wt. %, from 50 wt. % to 55 wt. %, from 55 wt. % to 75 wt. %, from 55 wt. % to 70 wt. %, from 55 wt. % to 65 wt. %, from 55 wt. % to 60 wt. %, from 60 wt. % to 75 wt. %, from 60 wt. % to 70 wt. %, from 60 wt. % to 65 wt. %, from 65 wt. % to 75 wt. %, from 65 wt. % to 70 wt. %, or from 70 wt. % to 75 wt. %.

Reference will now be made in detail to embodiments of methods for consuming acidic fluids. The methods of consuming acidic fluids may utilize any of the systems 100 and/or multilayer metallic balls 200 previously described.

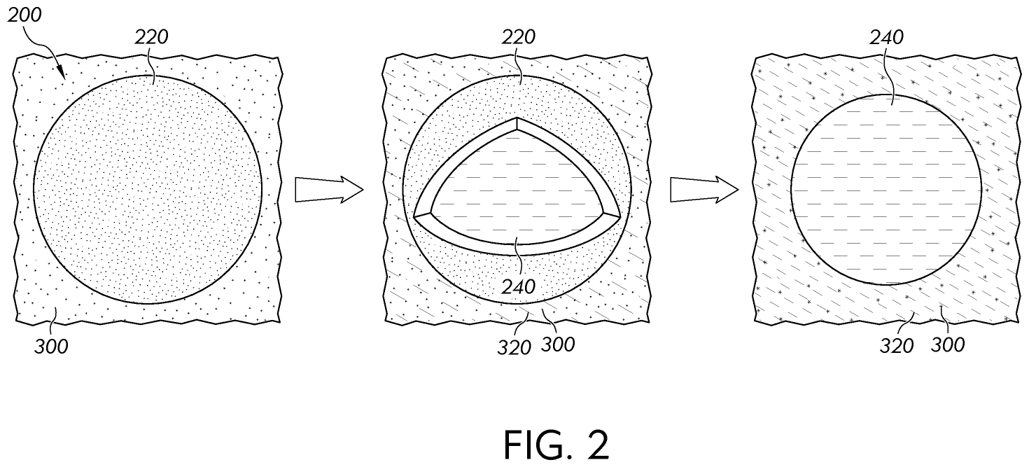

Referring now to FIG. 2, contacting the at least one multilayer metallic ball 200 with the acidic fluid 300 in the wellbore 110 may initially cause a portion of the metallic layer 220 to react with the acidic fluid 300, as shown in the left of FIG. 2. Upon reacting the portion of the metallic layer 220 with the acidic fluid 300, the portion of the metallic layer 220 is consumed exposing a portion of the core layer 240, and a portion of the acidic fluid is converted to a spent acidic fluid 320 and produce a mixture of the acidic fluid 300 and the spent acidic fluid 320. As shown in the middle of FIG. 2, at this stage, the fluid mixture may contain more the acidic fluid 300 than the spent acidic fluid 320. Once a portion of the core layer 240 is exposed, the exposed portion of the core layer 240 is in contact with the acidic fluid 300 and continues reacting with the acidic fluid 300 and converting the acidic fluid 300 to the spent acidic fluid 320, as shown in the right of FIG. 2. As the reaction continues, the fluidic mixture may contain more the spent acidic fluid 320 than the acidic fluid 300. Accordingly, the fluidic mixture become less reactive to the metal components (e.g. the casing 120 or the tubing 140) in the wellbore 110 and less hazardous to the field operator when the fluidic mixture is removed or flew back to the surface of the wellbore 110.

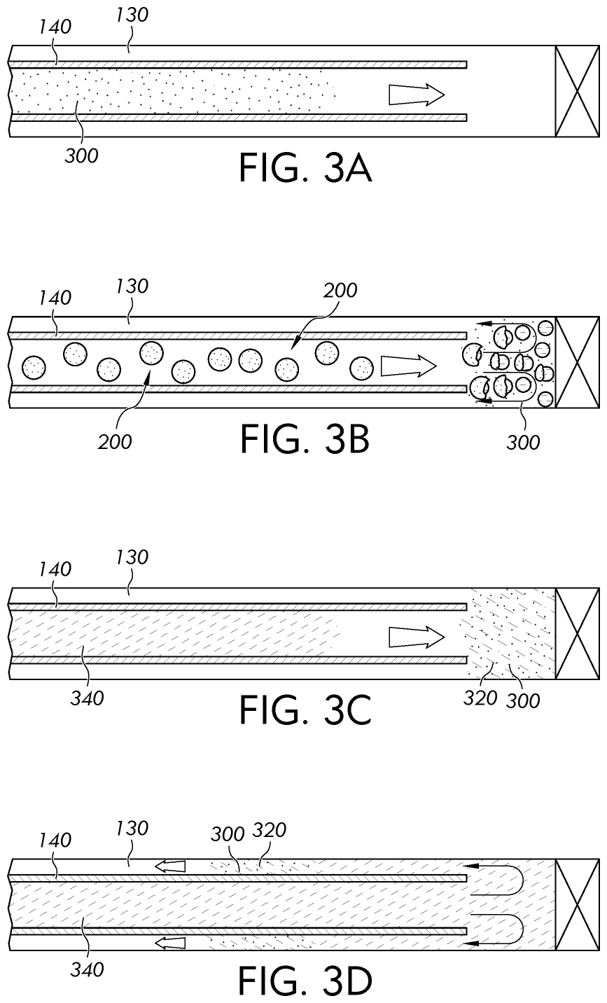

Now referring to FIG. 3, illustrated are methods of consuming an acidic fluid 300 in the wellbore 110. According to embodiments, a method of consuming an acidic fluid 300 in a wellbore 110 (FIG. 3A) may comprise injecting at least one multilayer metallic ball 200 disclosed hereinabove into the wellbore 110 disclosed hereinabove (FIG. 3B), contacting the multilayer metallic ball 200 with the acidic fluid 300 (FIG. 3B), thereby reacting at least a portion of the metallic layer 220 with the acidic fluid 300 at a first reaction rate (Rₘₑₜₐₗ) and exposing at least a portion of the core layer 240, and contacting the core layer 240 with the acidic fluid 300, thereby reacting at least a portion of the core layer 240 with the acidic fluid 300 at a second reaction rate (R_{core}) and consuming at least a portion of the core layer 240.

The methods disclosed hereinabove may further comprise removing the mixture of the acidic fluid 300 and the spent acidic fluid 320. For example, and as shown in FIG. 3C, the methods disclosed hereinabove may further comprise injecting a displacement fluid 340 into the wellbore 110. In some embodiments, injecting the displacement fluid 340 into the wellbore 110 may enable displacing at least a portion of the mixture of the acidic fluid and the spent acidic fluid, as shown in FIG. 3D. In some embodiments, the method may further comprise injecting additional displacement fluid 340 until the mixture of the acidic fluid 300 and the spent acidic fluid 320 is removed from the wellbore 110 through the tubing 140 or the wellbore annulus 130 defined by, for example, an inner diameter of the wellbore and an outer diameter of the tubing, as shown in FIGS. 1A and 1B.

According to embodiments, the methods disclosed herein may further comprise determining the extent or completeness of acid degradation, such as by assessing an average pH of the mixture of the acidic fluid 300 and the spent acidic fluid 320. For example, the process of consuming an acidic fluid 300 may be considered as substantially completed upon determining an average pH of the mixture of the acidic fluid 300 and the spent acidic fluid 320 is greater than or equal to 5.

In one or more embodiments, upon determining the process of consuming an acidic fluid 300 is not substantially completed or the average pH of the mixture of the acidic fluid 300 and the spent acidic fluid 320 is less than 5, the method may further comprise injecting at least one additional multilayer metallic ball 200 into the wellbore 110.

Upon determining the process of consuming an acidic fluid is completed or the average pH of the mixture of the acidic fluid 300 and the spent acidic fluid 320 is greater than or equal to 5, the displacement or removal of the mixture of the acidic fluid and the spent fluid may commence, such as by injecting the displacement fluid 340 into the wellbore 110 as described previously. The injecting of the displacement fluid 340 into the wellbore 110 may thereby displacing at least a portion of the mixture of the acidic fluid 300 and the spent acidic fluid 320. As previously stated, the method may further comprise injecting additional displacement fluid 340 until the mixture of the acidic fluid 300 and the spent acidic fluid 320 is removed from the wellbore 110 through the tubing 140 or the wellbore annulus 130. In further embodiments, the wellbore may comprise an average pressure within the wellbore greater than a pressure at the surface of the wellbore, such that the mixture of the acidic fluid and the spent acidic fluid may be flowed back to the surface of the wellbore as a result of the pressure difference.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is also noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “approximately” are utilized herein to represent the inherent degree of uncertainty that may be attributed to any quantitative or qualitative comparison, value, measurement, or other representation.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.” Likewise, utilization of the terms “having”, “has”, or their equivalents should likewise be interpreted in like manner as the more commonly used open-ended preamble term “comprising.”

What is claimed is:

1. A method of consuming an acidic fluid in a wellbore, comprising:
injecting at least one multilayer metallic ball into the wellbore, wherein
the at least one multilayer metallic ball comprises a core layer, a metallic layer encapsulating the core layer, and a ball density greater than the acidic fluid;
contacting the at least one multilayer metallic ball with the acidic fluid, thereby reacting at least a portion of the metallic layer with the acidic fluid at a first reaction rate (Rₘₑₜₐₗ) and exposing at least a portion of the core layer; and
contacting the core layer with the acidic fluid, thereby reacting at least a portion of the core layer with the acidic fluid at a second reaction rate (R_{core}) and consuming at least a portion of the core layer, wherein
reacting at least a portion of the metallic layer or the core layer with the acidic fluid converts at least a portion of the acidic fluid to a spent acidic fluid and forms a mixture of the acidic fluid and the spent acidic fluid.

2. The method of claim 1, wherein:
the wellbore further comprises a casing, a tubing, or combinations thereof;
at least a portion of the casing, the tubing, or combinations thereof reacts with the acidic fluid at a third reaction rate (R₃);
the first reaction rate (Rₘₑₜₐₗ) is greater than the third reaction rate (R₃); and
the second reaction rate (R_{core}) is greater than the third reaction rate (R₃).

3. The method of claim 1, wherein:
the multilayer metallic ball comprises a ball density (d_{Ball}) of from 1.2 g/cm³ to 8.9 g/cm³; and
the acidic fluid comprises a fluid density (d_{fluid}) of from 1.0 g/cm³ to 1.9 g/cm³, such that the multilayer metallic ball sinks in the acidic fluid.

4. The method of claim 1, wherein the metallic layer has a metal density (dₘₑₜₐₗ) from 2.0 g/cm³ to 11.3 g/cm³.

5. The method of claim 1, wherein the metallic layer comprises a metallic material comprising alkaline earth metals, aluminum, tin, zinc, cerium, neodymium, iron, nickel, lead, or combinations thereof.

6. The method of claim 5, wherein:
the metallic layer further comprises a non-metallic material comprising oxides, carbonates, polymers, or combinations thereof;
the oxides are selected from one or more of silica, alumina, iron oxides, cerium oxides, neodymium oxides, titanium oxides, andradite, alkaline metal oxides, copper oxides, and manganese oxide;
the carbonates are selected from one or more of calcium carbonates, magnesium carbonates, and iron carbonates; and
the polymers are selected from one or more of polysaccharides, polyacrylic acids, polylactic acids, and poly(vinylalcohol)s.

7. The method of claim 6, wherein the metallic layer comprises:
the metallic material comprising from 5 wt. % to 99.9 wt. % of the total weight of the metallic layer; and
the non-metallic material comprising from 0.1 wt. % to 95 wt. % of the total weight of the metallic layer.

8. The method of claim 1, wherein:
the core layer comprises a metallic material, a non-metallic material, or combinations thereof;
the metallic material comprises alkaline earth metals, aluminum, tin, zinc, cerium, neodymium, iron, nickel, lead, or combinations thereof;
the non-metallic material comprises oxides, carbonates, polymers, or combinations thereof;
the oxides are selected from one or more of silica, alumina, iron oxides, cerium oxides, neodymium oxides, titanium oxides, andradite, alkaline metal oxides, copper oxides, and manganese oxide;
the carbonates are selected from one or more of calcium carbonates, magnesium carbonates, and iron carbonates; and
the polymers are selected from one or more of polysaccharides, polyacrylic acids, polylactic acids, and poly(vinylalcohol)s.

9. The method of claim 8, wherein:
the core layer has a core density (d_{core}) of from 0.92 g/cm³ to 1.5 g/cm³; and
the core density (d_{core}) is less than or equal to the fluid density d_{fluid} such that the core layer suspends in the acidic fluid.

10. The method of claim 9, wherein:
the core layer comprises polymers; and
the polymers comprise from 70 wt. % to 95 wt. % of the total weight of the core layer.

11. The method of claim 8, wherein:
the core layer has a core density (d_{core}) greater than 1.5 g/cm³ to 7.2 g/cm³; and
the core density (d_{core}) is less than or equal to the fluid density druid such that the core layer suspends or floats in the acidic fluid.

12. The method of claim 11, wherein
the core layer comprises metallic materials, oxides, carbonates, or combinations thereof; and
the metallic materials, oxides, carbonates, or combinations thereof comprise greater than 30 wt. % of the total weight of the core layer.

13. The method of claim 1, further comprising assessing an average pH of the mixture of the acidic fluid and the spent acidic fluid.

14. The method of claim 13, wherein:
the wellbore further comprises a wellbore annulus defined by an inner diameter of the wellbore and an outer diameter of the tubing; and
the method further comprises, upon determining the average pH of the mixture is greater than or equal to 5,
injecting a displacement fluid into the wellbore, thereby displacing at least a portion of the mixture of the acidic fluid and the spent acidic fluid, and
injecting additional displacement fluid until the mixture of the acidic fluid and the spent acidic fluid is removed from the wellbore through the tubing or the wellbore annulus.

15. The method of claim 13, further comprising upon determining the average pH of the mixture of the acidic fluid and the spent acidic fluid is greater than or equal to 5, flowing back the mixture of the acidic fluid and the spent acidic fluid to a surface of the wellbore, wherein an average pressure within the wellbore is greater than the pressure at the surface.

16. The method of claim 13, further comprising upon determining the average pH of the mixture of the acidic fluid and the spent acidic fluid is less than 5, injecting at least one additional multilayer metallic ball into the wellbore.

17. The method of claim 1, wherein the at least one multilayer metallic ball comprises an initial radius of from 0.05 cm to 5 cm.

18. The method of claim 17, wherein the metallic layer and the core layer of the at least one multilayer metallic ball individually comprise nanoparticles comprising a diameter of from 5 nm to 200 nm.

19. A system for consuming an acidic fluid in a wellbore, comprising:
the wellbore;
the acidic fluid in the wellbore; and
at least one multilayer metallic ball comprising a core layer, a metallic layer encapsulating the core layer, and a ball density greater than the acidic fluid, wherein
the metallic layer is configured to react with the acidic fluid at a first reaction rate (Rₘₑₜₐₗ) and thereby convert a portion of the acidic fluid to a spent acidic fluid, the acidic fluid and the spent acidic fluid forming a mixture, and
the core layer is configured to react with the acidic fluid at a second reaction rate (R_{core}) and thereby convert another portion of the acidic fluid to additional spent acidic fluid.

20. The system of claim 19, wherein:
the wellbore further comprises a casing, a tubing, or combinations thereof;
the casing, the tubing, or combinations thereof reacts with the acidic fluid at a third reaction rate (R₃);
the first reaction rate (Rₘₑₜₐₗ) is greater than the third reaction rate (R₃); and
the second reaction rate (R_{core}) is greater than the third reaction rate (R₃).
